(19) United States
(12) Patent Application Publication
(10) Pub. No.: US 2022/0156552 A1
(43) Pub. Date: May 19, 2022

(54) DATA CONVERSION LEARNING DEVICE, DATA CONVERSION DEVICE, METHOD, AND PROGRAM

(71) Applicant: NIPPON TELEGRAPH AND TELEPHONE CORPORATION, Tokyo (JP)

(72) Inventors: Takuhiro KANEKO, Tokyo (JP); Hirokazu KAMEOKA, Tokyo (JP); Ko TANAKA, Tokyo (JP); Nobukatsu HOJO, Tokyo (JP)

(73) Assignee: NIPPON TELEGRAPH AND TELEPHONE CORPORATION, Tokyo (JP)

(21) Appl. No.: 17/433,588

(22) PCT Filed: Feb. 26, 2020
(86) PCT No.: PCT/JP2020/007658

§ 371 Date: Aug. 24, 2021

(30) Foreign Application Priority Data
Feb. 26, 2019 (JP) 2019-033199

(51) Int. Cl. G06N 3/04; G06K 9/62; G06F 9/38

(52) U.S. Cl. CPC G06N 3/04; G06F 9/3836; G06K 9/6256

(57) ABSTRACT

Accurate conversion to data of a conversion target domain is allowed. A training unit 32 trains a forward generator, an inverse generator, a conversion target discriminator, and a conversion source discriminator to optimize an objective function.

### TECHNICAL FIELD

The present invention relates to a data conversion training apparatus, a data conversion apparatus, a method, and a program, and particularly relates to a data conversion training apparatus, a data conversion apparatus, a method, and a program for converting data.

### BACKGROUND ART

There is known a method for achieving data conversion without requiring external data and an external module and without providing parallel data of series data (Non Patent Literatures 1 and 2).

In this method, training is performed using a cycle generative adversarial network (CycleGAN). In addition, an identity-mapping loss is used as a loss function during training, and a gated convolutional neural network (CNN) is used in a generator.

In the CycleGAN, a loss function including an adversarial loss which indicates whether or not conversion data belongs to a target and a cycle-consistency loss which indicates that conversion data returns to data before conversion by inversely converting the conversion data is used (FIG. 12).

Specifically, the CycleGAN includes a forward generator G_{X→Y}, an inverse generator G_{Y→X}, a conversion target discriminator D_{Y}, and a conversion source discriminator D_{X}. The forward generator G_{X→Y} forwardly converts source data x to target data G_{X→Y}(x). The inverse generator G_{Y→X} inversely converts target data y to source data G_{Y→X}(y). The conversion target discriminator D_{Y} distinguishes between conversion target data G_{X→Y}(x) (product, imitation) and target data y (authentic data). The conversion source discriminator D_{X} distinguishes between the conversion source data G_{Y→X}(x) (product, imitation) and source data x (authentic data).

The adversarial loss is expressed by the following Equation (1). This adversarial loss is included in the objective function.

[Math. 1]

[symbol]

_{adv}(G_{X→Y},D_{Y})= [symbol] _{˜P}_{_{Y}}( [symbol] )[log D_{Y}( [symbol] )]+ [symbol] _{x˜P}_{_{X}}₍ₓ₎[log(1−D_{Y}(G_{X→Y}(x)))], (1)

With regard to the adversarial loss, when the conversion target discriminator D_{Y} distinguishes between each of the conversion target data G_{X→Y}(x) (product, imitation) and the authentic target data y, the conversion target discriminator D_{Y} is trained to maximize the adversarial loss so as to distinguish between imitation and authentic data without being fooled by the forward generator G_{X→Y}. The forward generator G_{X→Y} is trained to minimize the adversarial loss so as to generate data that can fool the conversion target discriminator D_{Y}.

The cycle-consistency loss is expressed by the following Equation (2). This cycle-consistency loss is included in the objective function.

[Math. 2]

[symbol]

_{cyc}(G_{X→Y},G_{Y→X})= [symbol] _{x˜P}_{_{X}}₍ₓ₎[∥G_{Y→X}(G_{X→Y}(x))−x∥₁]+ [symbol] [∥G_{X→Y}(G_{Y→X}( [symbol] ))− [symbol] ∥₁], (2)

The adversarial loss only gives a constraint to make data more authentic and thus is not always capable of proper conversion. Thus, the cycle-consistency loss gives a constraint (x=G_{Y→X} (G_{X→Y}(x))) so that data G_{Y→X} (G_{X→Y}(x)) obtained by forwardly converting the source data x by the forward generator G_{X→Y} and inversely converting it by the inverse generator G_{Y→X} returns to the original source data x to train the generators G_{X→Y} and G_{Y→X} while searching for simulated paired data.

The identity-mapping loss is expressed in the following Equation (3) (FIG. 13). This identity-mapping is included in the objective function.

[Math. 3]

[symbol]

_{id}(G_{X→Y},G_{Y→X})= [symbol] [∥(G_{X→Y}( [symbol] )− [symbol] ∥₁]+ [symbol] _{x˜P}_{_{X}}₍ₓ₎[∥G_{Y→X}(x)−x∥₁]. (3)

The above identity-mapping loss gives a constraint so that the generators G_{X→Y} and G_{Y→X} retain input information.

The generators are configured using the gated CNN illustrated in FIG. 14. In this gated CNN, information is propagated while being data-driven-selected between the 1-th layer and the (l+1)-th layer. As a result, the serial structure and the hierarchical structure of time series data can be efficiently expressed.

### CITATION LIST

### Non Patent Literature

Non Patent Literature 1: T. Kaneko and H. Kameoka, “CycleGAN-VC: Non-parallel Voice Conversion Using Cycle-Consistent Adversarial Networks,” 2018 26th European Signal Processing Conference (EUSIPCO).

Non Patent Literature 2: T. Kaneko and H. Kameoka, “Parallel-data-free Voice Conversion Using Cycle-consistent Adversarial Networks,” in arXiv preprint arXiv: 1711. 11293, Nov. 30, 2017.

### SUMMARY OF THE INVENTION

### Technical Problem

In the cycle-consistency loss expressed in Equation (2) above, the distance between the source data x and the data G_{Y→X} (G_{X→Y}(x)) obtained by forward conversion and inverse conversion of the source data x is measured by an explicit distance function (e.g., L1). This distance is actually complex in shape, but is smoothed as a result of approximating it by the explicit distance function (e.g., L1).

In addition, the data G_{Y→X} (G_{X→Y}(x)) obtained by forward conversion and inverse conversion is a result of training by using the distance function and thus is likely to be generated as high quality data, which is difficult to distinguish; however, the data G_{Y→X}(y) obtained by forward conversion of the source data is not a result of training by using the distance function and thus is likely to be generated as low quality data, which is easy to distinguish. When training proceeds to enable distinguishing of high quality data, low quality data can be easily distinguished and is likely to be ignored, which makes the training difficult to proceed.

The present invention has been made to solve the problems described above, and an object of the present invention is to provide a data conversion training apparatus, method, and program that can train a generator capable of accurately converting data to data of a conversion target domain.

Further, an object of the present invention is to provide a data conversion apparatus capable of accurately converting data to data of a conversion target domain.

### Means for Solving the Problem

In order to achieve the object described above, a data conversion training apparatus according to a first aspect includes: an input unit configured to receive a set of data of a conversion source domain and a set of data of a conversion target domain; and a training unit configured to train a forward generator and an inverse generator, the forward generator being configured to generate data of the conversion target domain from data of the conversion source domain based on the set of data of the conversion source domain and the set of data of the conversion target domain, the inverse generator being configured to generate data of the conversion source domain from data of the conversion target domain, in which the training unit trains the forward generator, the inverse generator, a first conversion target discriminator, a second conversion target discriminator, a first conversion source discriminator, and a second conversion source discriminator so as to optimize a value of an objective function expressed by using: a distinguishing result, by the first conversion target discriminator, for forward generation data generated by the forward generator, the first conversion target discriminator being configured to distinguish whether data is the forward generation data generated by the forward generator; a distinguishing result, by the first conversion target discriminator, for the data of the conversion target domain; a distance between the data of the conversion source domain and inverse generation data generated by the inverse generator from the forward generation data generated by the forward generator from the data of the conversion source domain; a distinguishing result, by the second conversion source discriminator, for the inverse generation data generated by the inverse generator from the forward generation data, the second conversion source discriminator being configured to distinguish whether data is the inverse generation data generated by the inverse generator; a distinguishing result, by the first conversion source discriminator, for inverse generation data generated by the inverse generator, the first conversion source discriminator being configured to distinguish whether data is the inverse generation data generated by the inverse generator; a distinguishing result, by the first conversion source discriminator, for the data of the conversion source domain; a distance between the data of the conversion target domain and forward generation data generated by the forward generator from the inverse generation data generated by the inverse generator from the data of the conversion target domain; and a distinguishing result, by the second conversion target discriminator, for the forward generation data generated by the forward generator from the inverse generation data, the second conversion target discriminator being configured to distinguish whether data is the forward generation data generated by the forward generator.

A data conversion training apparatus according to a second aspect includes: an input unit configured to receive a set of data of a conversion source domain and a set of data of a conversion target domain; and a training unit configured to train, based on the set of data of the conversion source domain and the set of data of the conversion target domain, a forward generator, an inverse generator, a conversion target discriminator, and a conversion source discriminator, the forward generator being configured to generate data of the conversion target domain from data of the conversion source domain, the inverse generator being configured to generate data of the conversion source domain from data of the conversion target domain, the conversion target discriminator being configured to distinguish whether data is forward generation data generated by the forward generator, the conversion source discriminator being configured to distinguish whether data is inverse generation data generated by the inverse generator, in which the forward generator includes: a down-sampling converter configured to perform down-sampling in which a local structure of the data of the conversion source domain is retained; a dynamic converter configured to dynamically convert output data of the down-sampling converter; and an up-sampling converter configured to generate the forward generation data by up-sampling of output data of the dynamic converter, and the inverse generator includes: a down-sampling converter configured to perform down-sampling in which a local structure of the data of the conversion target domain is retained; a dynamic converter configured to dynamically convert output data of the down-sampling converter and an up-sampling converter configured to generate the inverse generation data by up-sampling of output data of the dynamic converter.

A data conversion apparatus according to a third aspect includes: an input unit configured to receive data of a conversion source domain; and a data conversion unit configured to generate data of a conversion target domain from the data of the conversion source domain received by the input unit, by using a forward generator configured to generate the data of the conversion target domain from the data of the conversion source domain, in which the forward generator includes: a down-sampling converter configured to perform down-sampling in which a local structure of the data of the conversion source domain is retained; a dynamic converter configured to dynamically convert output data of the down-sampling converter; and an up-sampling converter configured to generate forward generation data by up-sampling of output data of the dynamic converter.

A data conversion training method according to a fourth aspect includes: receiving, by an input unit, a set of data of a conversion source domain and a set of data of a conversion target domain; and training, by a training unit a forward generator and an inverse generator, the forward generator being configured to generate data of the conversion target domain from data of the conversion source domain based on the set of data of the conversion source domain and the set of data of the conversion target domain, the inverse generator being configured to generate data of the conversion source domain from data of the conversion target domain, in which the data conversion training method includes training the forward generator, the inverse generator, a first conversion target discriminator, a second conversion target discriminator, a first conversion source discriminator, and a second conversion source discriminator so as to optimize a value of an objective function expressed by using: a distinguishing result, by the first conversion target discriminator, for forward generation data generated by the forward generator, the first conversion target discriminator being configured to distinguish whether data is the forward generation data generated by the forward generator; a distinguishing result, by the first conversion target discriminator, for the data of the conversion target domain; a distance between the data of the conversion source domain and inverse generation data generated by the inverse generator from the forward generation data generated by the forward generator from the data of the conversion source domain; a distinguishing result, by the second conversion source discriminator, for inverse generation data generated by the inverse generator from the forward generation data, the second conversion source discriminator being configured to distinguish whether data is the inverse generation data generated by the inverse generator; a distinguishing result, by the first conversion source discriminator, for inverse generation data generated by the inverse generator, the first conversion source discriminator being configured to distinguish whether data is the inverse generation data generated by the inverse generator; a distinguishing result, by the first conversion source discriminator, for the data of the conversion source domain; a distance between the data of the conversion target domain and forward generation data generated by the forward generator from the inverse generation data generated by the inverse generator from the data of the conversion target domain; and a distinguishing result, by the second conversion target discriminator, for forward generation data generated by the forward generator from the inverse generation data, the second conversion target discriminator being configured to distinguish whether data is the forward generation data generated by the forward generator.

Further, a data conversion training method according to a fifth aspect includes: receiving, by an input unit, a set of data of a conversion source domain and a set of data of a conversion target domain; and training, by a training unit, based on the set of data of the conversion source domain and the set of data of the conversion target domain, a forward generator, an inverse generator, a conversion target discriminator, and a conversion source discriminator, the forward generator being configured to generate data of the conversion target domain from data of the conversion source domain, the inverse generator being configured to generate data of the conversion source domain from data of the conversion target domain, the conversion target discriminator being configured to distinguish whether data is forward generation data generated by the forward generator, the conversion source discriminator being configured to distinguish whether data is inverse generation data generated by the inverse generator, in which the forward generator includes: a down-sampling converter configured to perform down-sampling in which a local structure of the data of the conversion source domain is retained; a dynamic converter configured to dynamically convert output data of the down-sampling converter; and an up-sampling converter configured to generate the forward generation data by up-sampling of output data of the dynamic converter, and the inverse generator includes: a down-sampling converter configured to perform down-sampling in which a local structure of the data of the conversion target domain is retained; a dynamic converter configured to dynamically convert output data of the down-sampling converter; and an up-sampling converter configured to generate the inverse generation data by up-sampling of output data of the dynamic converter.

A data conversion method according to a sixth aspect includes: receiving, by an input unit, data of a conversion source domain; and generating, by a data conversion unit, data of a conversion target domain from the data of the conversion source domain received by the input unit, by using a forward generator configured to generate the data of the conversion target domain from the data of the conversion source domain, in which the forward generator includes: a down-sampling converter configured to perform down-sampling in which a local structure of the data of the conversion source domain is retained; a dynamic converter configured to dynamically convert output data of the down-sampling converter; and an up-sampling converter configured to generate forward generation data by up-sampling of output data of the dynamic converter.

A program according to a seventh aspect is a program for causing a computer to execute: receiving a set of data of a conversion source domain and a set of data of a conversion target domain, and training a forward generator and an inverse generator, the forward generator being configured to generate data of the conversion target domain from data of the conversion source domain based on the set of data of the conversion source domain and the set of data of the conversion target domain, the inverse generator being configured to generate data of the conversion source domain from data of the conversion target domain, in which the computer executes training the forward generator, the inverse generator, a first conversion target discriminator, a second conversion target discriminator, a first conversion source discriminator, and a second conversion source discriminator so as to optimize a value of an objective function expressed by using: a distinguishing result, by the first conversion target discriminator, for forward generation data generated by the forward generator, the first conversion target discriminator being configured to distinguish whether data is the forward generation data generated by the forward generator; a distinguishing result, by the first conversion target discriminator, for the data of the conversion target domain; a distance between the data of the conversion source domain and inverse generation data generated by the inverse generator from the forward generation data generated by the forward generator from the data of the conversion source domain; a distinguishing result, by the second conversion source discriminator, for inverse generation data generated by the inverse generator from the forward generation data, the second conversion source discriminator being configured to distinguish whether data is the inverse generation data generated by the inverse generator; a distinguishing result, by the first conversion source discriminator, for inverse generation data generated by the inverse generator, the first conversion source discriminator being configured to distinguish whether data is the inverse generation data generated by the inverse generator a distinguishing result, by the first conversion source discriminator, for the data of the conversion source domain a distance between the data of the conversion target domain and forward generation data generated by the forward generator from the inverse generation data generated by the inverse generator from the data of the conversion target domain; and a distinguishing result, by the second conversion target discriminator, for forward generation data generated by the forward generator from the inverse generation data, the second conversion target discriminator being configured to distinguish whether data is the forward generation data generated by the forward generator.

A program according to an eighth aspect is a program for causing a computer to execute: receiving a set of data of a conversion source domain and a set of data of a conversion target domain; and training, based on the set of data of the conversion source domain and the set of data of the conversion target domain, a forward generator, an inverse generator, a conversion target discriminator, and a conversion source discriminator, the forward generator being configured to generate data of the conversion target domain from data of the conversion source domain, the inverse generator being configured to generate data of the conversion source domain from data of the conversion target domain, the conversion target discriminator being configured to distinguish whether data is forward generation data generated by the forward generator, the conversion source discriminator being configured to distinguish whether data is inverse generation data generated by the inverse generator, in which the forward generator includes: a down-sampling converter configured to perform down-sampling in which a local structure of the data of the conversion source domain is retained; a dynamic converter configured to dynamically convert output data of the down-sampling converter; and an up-sampling converter configured to generate the forward generation data by up-sampling of output data of the dynamic converter, and the inverse generator includes: a down-sampling converter configured to perform down-sampling in which a local structure of the data of the conversion target domain is retained; a dynamic converter configured to dynamically convert output data of the down-sampling converter; and an up-sampling converter configured to generate the inverse generation data by up-sampling of output data of the dynamic converter.

A program according to a ninth aspect is a program for causing a computer to execute: receiving data of a conversion source domain; and generating data of a conversion target domain from the data of the conversion source domain received, by using a forward generator configured to generate the data of the conversion target domain from the data of the conversion source domain, in which the forward generator includes: a down-sampling converter configured to perform down-sampling in which a local structure of the data of the conversion source domain is retained; a dynamic converter configured to dynamically convert output data of the down-sampling converter and an up-sampling converter configured to generate forward generation data by up-sampling of output data of the dynamic converter.

### Effects of the Invention

According to the data conversion training apparatus, method, and program according to an aspect of the present invention, an effect is obtained in which a generator can be trained so as to be capable of accurate conversion to data of a conversion target domain.

According to the data conversion apparatus, method, and program according to an aspect of the present invention, an effect of accurate conversion to data of a conversion target domain is obtained.

### BRIEF DESCRIPTION OF DRAWINGS

FIG. 1 is a diagram for describing a method of training processing according to an embodiment of the present invention.

FIG. 2 is a block diagram illustrating a configuration of a generator according to the embodiment of the present invention.

FIG. 3 is a diagram illustrating a configuration of a discriminator according to the embodiment of the present invention.

FIG. 4 is a block diagram illustrating a configuration of a data conversion training apparatus according to the embodiment of the present invention.

FIG. 5 is a block diagram illustrating a configuration of a data conversion apparatus according to an embodiment of the present invention.

FIG. 6 is a schematic block diagram of an example of a computer that functions as a data conversion training apparatus or a data conversion apparatus.

FIG. 7 is a flowchart of a data conversion training processing routine in the data conversion training apparatus according to the embodiment of the present invention.

FIG. 8 is a flowchart of processing for training a generator and a discriminator in the data conversion training apparatus according to the embodiment of the present invention.

FIG. 9 is a flowchart of a data conversion processing routine in the data conversion apparatus according to the embodiment of the present invention.

FIG. 10 is a diagram illustrating a network configuration of a generator.

FIG. 11 is a diagram illustrating a network configuration of a discriminator.

FIG. 12 is a diagram for describing a CycleGAN of the related art.

FIG. 13 is a diagram for describing an identity-mapping loss of the related art.

FIG. 14 is a diagram for describing a gated CNN of the related art.

FIG. 15 is a diagram for describing a 1D CNN of the related art.

FIG. 16 is a diagram for describing a generator using the 1D CNN of the related art.

FIG. 17 is a diagram for describing a 2D CNN of the related art.

FIG. 18 is a diagram for describing a generator using the 2D CNN of the related art.

FIG. 19 is a diagram for describing a discriminator of the related art.

### DESCRIPTION OF EMBODIMENTS

Hereinafter, embodiments of the present invention will be described in detail with reference to the drawings.

### Overview of Embodiment of Present Invention

First, an overview of an embodiment of the present invention will be described.

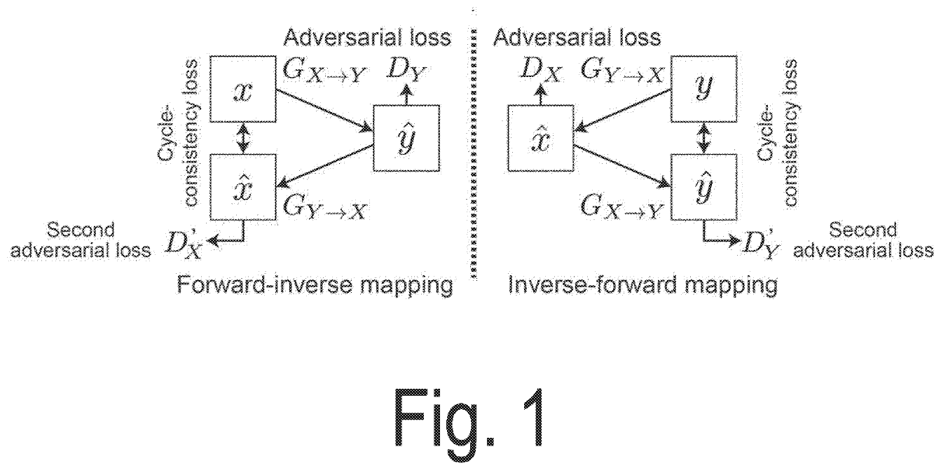

In the embodiment of the present invention, the CycleGAN is improved and a conversion source discriminator D_{X}′ and a conversion target discriminator D_{Y}′ are added as components (see FIG. 1). For each of data G_{Y→X} (G_{X→Y}(x)) obtained by forward conversion and inverse conversion of source data x and the source data x, the conversion source discriminator D_{X}′ distinguishes whether it is a product or an imitation or it is authentic data. For each of data G_{X→Y} (G_{Y→X}(x)) obtained by inverse conversion and forward conversion of target data y and the target data y, the conversion target discriminator D_{Y}′ distinguishes whether it is a product or an imitation or it is authentic data. This is for properly distinguishing fake data having a different quality. Here, high quality fake data refers to fake data that also trains a loss function measuring a distance between the fake data and real data (target data) and is relatively close to the real data. Low quality fake data refers to fake data that is free of such constraints. The above-described components are added because it is desirable to properly handle both of the fake data, while one discriminator adequately handles two types of fake data that differ in quality as described above.

The objective function further includes a second adversarial loss expressed in the following Equation (4) below.

[Math. 4]

[symbol]

_{adv2}(G_{X→Y},G_{Y→X},D′_{X})= [symbol] _{x˜P}_{_{X}}₍ₓ₎[log D′_{X}(x)]+ [symbol] _{x˜P}_{_{X}}₍ₓ₎[log(1−D′_{X}(G_{Y→X}(G_{X→Y}(x))))]. (4)

The conversion source discriminator D_{X}′ is trained to correctly distinguish between a product or an imitation and authentic data by maximizing the second adversarial loss so as not to be fooled by the forward generator G_{X→Y} and the inverse generator G_{Y→X}. On the other hand, the forward generator G_{X→Y} and the inverse generator G_{Y→X} are trained to generate data that can fool the conversion source discriminator D_{X}′ by minimizing the second adversarial loss.

A data conversion training apparatus or a data conversion apparatus according to the embodiment of the present invention preferably separately trains a parameter of the conversion source discriminator D_{X} that distinguishes each of source data x and data G_{Y→X}(y) obtained by inverse conversion and a parameter of the conversion source discriminator D_{X}′ that distinguishes each of source data x and data G_{Y→X}(x)) obtained by forward conversion and inverse conversion.

Moreover, for the conversion target discriminator D_{Y}′, similarly to the above Equation (4), the second adversarial loss is defined and included in the objective function.

That is, the final objective function is expressed by the following Equation (5).

[Math. 5]

[symbol]

_{full}= [symbol] _{adv}(G_{X→Y},D_{Y})+ [symbol] _{adv}(G_{Y→X},D_{X})+λ_{cyc} [symbol] _{cyc}(G_{X→Y},G_{Y→X})+λ_{id} [symbol] _{id}(G_{X→Y},G_{Y→X})+ [symbol] _{adv2}(G_{X→Y},G_{Y→X},D′_{X})+ [symbol] _{adv2}(G_{Y→X},G_{X→Y},D′_{Y}) (5)

In addition, in the present embodiment, the network structure of the generator is modified to be a combination of a 1D CNN and a 2D CNN.

Here, the 1D CNN and the 2D CNN will be described.

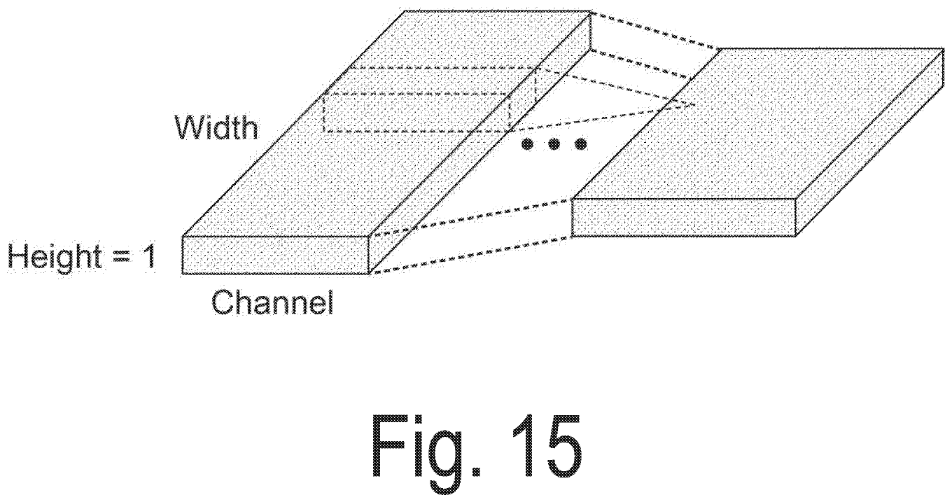

In the 1D CNN, as illustrated in FIG. 15, in down-sampling by convolution, convolution in the entire domain in the channel direction and a local domain in the width direction of data is used.

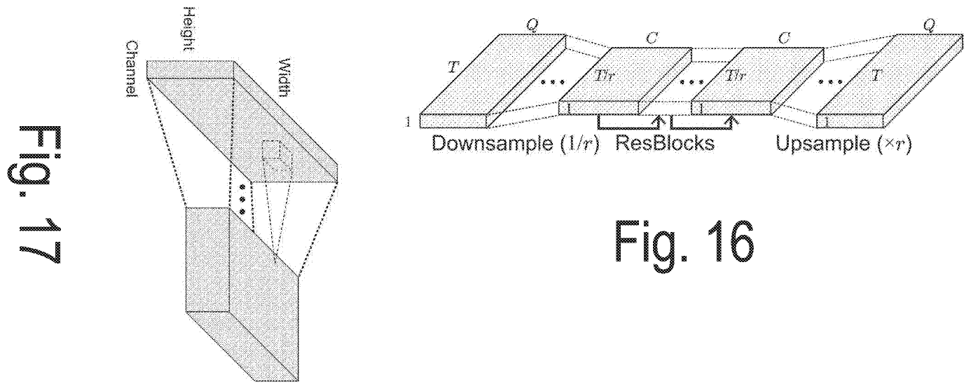

For example, as illustrated in FIG. 16, in a generator using the 1D CNN, it is assumed that the width is a time T and the channel is a feature dimension Q. At this time, in the generator using the 1D CNN, at the time of convolution, a local relationship is seen in the time direction (T), and all relationships are seen in the feature dimension direction (Q). This facilitates representation of dynamic changes, while it may lead to excessive change and lose a detailed structure. For example, in the case of speech, a large change from a male to a female is easily represented, while a thin structure representing naturalness of voice is lost to increase a synthesized sound sensation.

Moreover, in the generator using the 1D CNN, down-sampling is performed in the time direction to efficiently see a relationship in the time direction, and dimensions are instead increased in the channel direction. Next, a main converter including a plurality of layers gradually performs conversion. Then, up-sampling is performed in the time direction to perform returning to the original size.

In this way, in the generator using the 1D CNN, dynamic conversion may be possible while detailed information may be lost.

In the 2D CNN, as illustrated in FIG. 17, in down-sampling by convolution, convolution in a local domain in the channel direction and a local domain in the width direction of data is used.

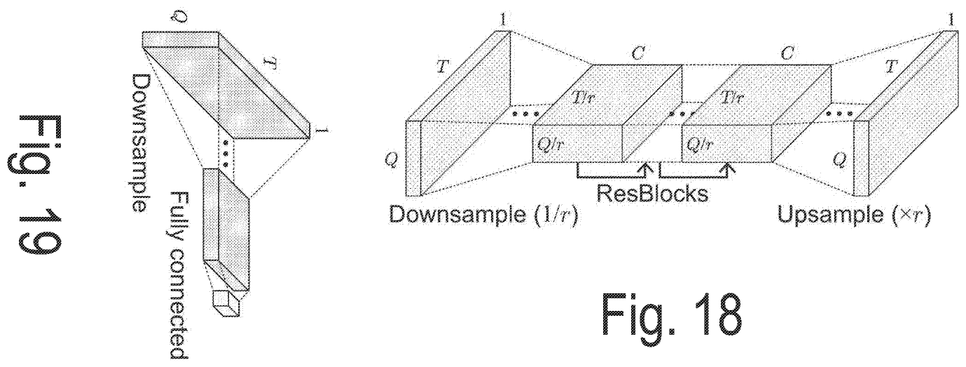

For example, as illustrated in FIG. 18, in a generator using the 2D CNN, when it is assumed that the width is a time T and that the channel is a feature dimension Q, at the time of convolution, a local relationship is seen in the time direction (T) and a local relationship is also seen in the feature dimension direction (Q). This makes a conversion range localized and easily retains a detailed structure, while it is difficult to represent a dynamic change. For example, in the case of speech, a thin structure representing naturalness of voice is easily retained, while it is difficult to represent a large conversion from a male to a female and a neutral voice is produced.

Furthermore, in the generator using the 2D CNN, down-sampling is performed in the time direction and the feature dimension direction to efficiently see a relationship in the time direction and the feature dimension direction, and dimensions are instead increased in the channel direction. Next, the main converter including a plurality of layers gradually performs conversion. Up-sampling is then performed in the time direction and the feature dimension direction to perform returning to the original size.

In this way, in the generator using the 2D CNN, it is possible to retain detailed information, while dynamic conversion is difficult.

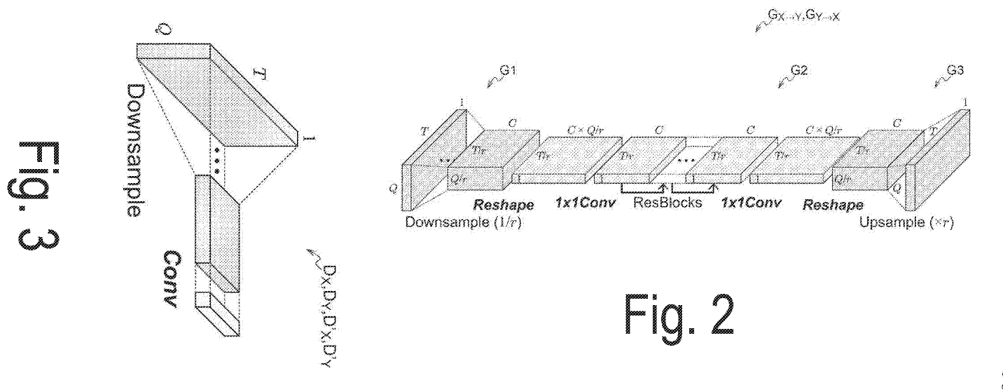

In the embodiment of the present invention, a combination of the 2D CNN and the 1D CNN is used as the generator. For example, as illustrated in FIG. 2, the generator includes a down-sampling converter G1, a main converter G2, and an up-sampling converter G3. First, the down-sampling converter G1 performs down-sampling in the time direction and the feature dimension direction so as to efficiently see a relationship in the time direction and the feature dimension direction, similarly to the generator using the 2D CNN. Next, the main converter G2 performs changing to a shape tailored to the 1D CNN, and then performs compression in the channel direction. Next, the main converter G2 performs dynamic conversion by the 1D CNN. The main converter G2 performs extension in the channel direction and performs changing to a shape tailored to the 2D CNN. The up-sampling converter G3 performs up-sampling in the time direction and the feature dimension direction and performs returning to the original size, similarly to the generator using the 2D CNN. Note that the main converter G2 is an example of a dynamic converter.

Here, in parts of down-sampling and up-sampling, the 2D CNN is used to give priority to retention of the detailed structure.

As described above, in the present embodiment, by using the combination of the 2D CNN and the 1D CNN as the generator, it is possible to retain a detailed structure using the 2D CNN, and to perform dynamic conversion using the 1D CNN.

In the main converter, for example, a normal network expressed by the following equation may be used.

y=F(x)

However, in the above-described network, source information (x) may be lost during conversion.

Thus, in the embodiment of the present invention, in the main converter, for example, a residual network expressed by the following equation is used.

y=x+R(x)

In the residual network described above, it is possible to perform conversion while retaining the source information (x). In this way, in the main converter, retention of the detailed structure from the source is possible by the residual structure, and thus using the 1D CNN in the generator enables both dynamic conversion and retention of the detailed structure.

In addition, in the embodiment of the present invention, the network structure of a discriminator in the related art is improved.

In the related art, as illustrated in FIG. 19, a fully connected layer is used in the final layer of the discriminator, and thus the number of parameters is large and training is difficult.

In the present embodiment, as illustrated in FIG. 3, because a convolutional layer is used in place of the fully connected layer in the final layer of the discriminator, and thus the number of parameters decreases, and the difficulty in training is alleviated.

Configuration of Data Conversion Training Apparatus According to Embodiment of Present Invention

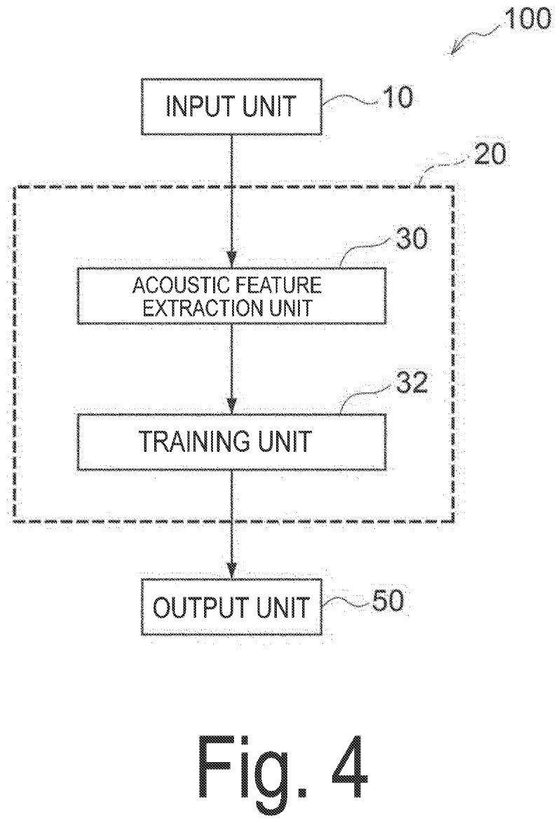

Next, a configuration of a data conversion training apparatus according to an embodiment of the present invention will be described. As illustrated in FIG. 4, a data conversion training apparatus 100 according to the embodiment of the present invention can be configured by a computer including a CPU, a RAM, a ROM that stores a program or various data for executing a data conversion training processing routine described later. The data conversion training apparatus 100 functionally includes an input unit 10, an operation unit 20, and an output unit 50 as illustrated in FIG. 4.

The input unit 10 receives a set of speech signals of a conversion source domain and a set of speech signals of a conversion target domain.

The operation unit 20 includes an acoustic feature extraction unit 30 and a training unit 32.

The acoustic feature extraction unit 30 extracts an acoustic feature sequence from each of speech signals included in the input set of speech signals of the conversion source domain. The acoustic feature extraction unit 30 also extracts an acoustic feature sequence from each of speech signals included in the input set of speech signals of the conversion target domain.

The training unit 32 trains the forward generator G_{X→Y} and the inverse generator G_{Y→X}. Here, the forward generator G_{X→Y} generates an acoustic feature sequence of a speech signal of the conversion target domain from an acoustic feature sequence of a speech signal of the conversion source domain based on an acoustic feature sequence in each of speech signals of the conversion source domain and an acoustic feature sequence in each of speech signals of the conversion target domain. The inverse generator G_{Y→X} generates an acoustic feature sequence of a speech signal of the conversion source domain from an acoustic feature sequence of a speech signal of the conversion target domain.

Specifically, the training unit 32 trains the forward generator G_{X→Y} and the inverse generator G_{Y→X} so as to minimize the value of the objective function. In addition, the training unit 32 trains the conversion target discriminators D_{Y} and D_{Y}′ and the conversion source discriminators D_{X} and D_{X}′ so as to maximize the value of the objective function expressed in Equation (5) above. At this time, parameters of the conversion target discriminators D_{Y} and D_{Y}′ are trained separately, and parameters of the conversion source discriminators D_{X} and D_{X}′ are trained separately.

This objective function is expressed using 10 types of results, each of which is described next, as expressed in Equation (5) above. The first one is a distinguishing result (a) for forward generation data generated by the forward generator G_{X→Y}, which is obtained by the conversion target discriminator D_{Y} that distinguishes whether data is the forward generation data generated by the forward generator G_{X→Y}. The second one is a distance (b) between an acoustic feature sequence of a speech signal of a conversion source domain and inverse generation data generated by the inverse generator G_{Y→X} from the forward generation data generated by the forward generator G_{X→Y} from the acoustic feature sequence of the speech signal of the conversion source domain. The third one is a distinguishing result (c) for the inverse generation data generated by the inverse generator G_{Y→X} from the forward generation data, which is obtained by the conversion source discriminator D_{X}′ that distinguishes whether data is the inverse generation data generated by the inverse generator G_{Y→X}. The fourth one is a distinguishing result (d) for inverse generation data generated by the inverse generator G_{Y→X}, which is obtained by the conversion source discriminator D_{X} that distinguishes whether data is the inverse generation data generated by the inverse generator G_{Y→X}. The fifth one is a distance (e) between the acoustic feature sequence of the speech signal of the conversion target domain and forward generation data generated by the forward generator G_{X→Y} from the inverse generation data generated by the inverse generator G_{Y→X} from the acoustic feature sequence of the speech signal of the conversion target domain. The sixth one is a distinguishing result (f) for the forward generation data generated by the forward generator G_{X→Y} from the inverse generation data, which is obtained by the conversion target discriminator D_{Y}′ that distinguishes whether data is the forward generation data generated by the forward generator G_{X→Y}. The seventh one is a distinguishing result (g) for the acoustic feature sequence of the speech signal of the conversion target domain, which is obtained by the conversion target discriminator D_{Y}. The eighth one is a distinguishing result (h) for the acoustic feature sequence of the speech signal of the conversion source domain, which is obtained by the conversion source discriminator D_{X}. The ninth one is a distance (i) between the acoustic feature sequence of the speech signal of the conversion target domain and the forward generation data generated by the forward generator G_{X→Y} from the acoustic feature sequence of the speech signal of the conversion target domain. The last one is a distance (j) between the acoustic feature sequence of the speech signal of the conversion source domain and the inverse generation data generated by the inverse generator G_{Y→X} from the acoustic feature sequence of the speech signal of the conversion source domain.

The training unit 32 repeats the training of the forward generator G_{X→Y}, the inverse generator G_{Y→X}, the conversion target discriminators D_{Y} and D_{Y}′, and the conversion source discriminators D_{X} and D_{X}′ described above until a predetermined ending condition is satisfied, and outputs the forward generator G_{X→Y} and the inverse generator G_{Y→X}, which are finally obtained, by the output unit 50. Here, each of the forward generator G_{X→Y} and the inverse generator G_{Y→X} is a combination of the 2D CNN and the 1D CNN, and includes a down-sampling converter G1, a main converter G2, and an up-sampling converter G3. The down-sampling converter G1 of the forward generator G_{X→Y} performs down-sampling that retains a local structure of an acoustic feature sequence of a speech signal of the conversion source domain. The main converter G2 dynamically converts output data of the down-sampling converter G1. The up-sampling converter G3 generates the forward generation data by up-sampling of output data of the main converter G2.

The down-sampling converter G1 of the inverse generator G_{Y→X} performs down-sampling that retains a local structure of an acoustic feature sequence of a speech signal of a conversion target domain. The main converter G2 dynamically converts output data of the down-sampling converter G1. The up-sampling converter G3 generates inverse generation data by up-sampling of output data of the main converter G2.

Further, each of the forward generator G_{X→Y} and the inverse generator G_{Y→X} is configured so that, for some layers, the output is calculated using the gated CNN.

Further, each of the conversion target discriminators D_{Y} and D_{Y}′ and the conversion source discriminators D_{X} and D_{X}′ is constituted using a neural network configured so that the final layer includes a convolutional layer.

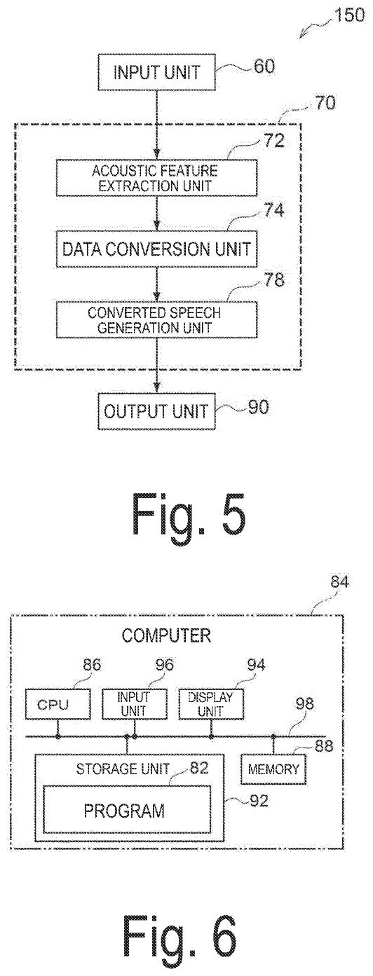

Configuration of data conversion apparatus according to embodiment of present invention Next, a configuration of a data conversion apparatus according to the embodiment of the present invention will be described. As illustrated in FIG. 5, a data conversion apparatus 150 according to the embodiment of the present invention can be configured by a computer including a CPU, a RAM, a ROM that stores a program or various data for executing a data conversion processing routine described later. The data conversion apparatus 150 functionally includes an input unit 60, an operation unit 70, and an output unit 90 as illustrated in FIG. 5.

The input unit 60 receives a speech signal of a conversion source domain as an input.

The operation unit 70 includes an acoustic feature extraction unit 72, a data conversion unit 74, and a converted speech generation unit 78.

The acoustic feature extraction unit 72 extracts an acoustic feature sequence from an input speech signal of the conversion source domain.

The data conversion unit 74 uses the forward generator G_{X→Y} trained by the data conversion training apparatus 100 to estimate an acoustic feature sequence of a speech signal of a conversion target domain from the acoustic feature sequence extracted by the acoustic feature extraction unit 72.

The converted speech generation unit 78 generates a time domain signal from the estimated acoustic feature sequence of the speech signal of the conversion target domain and outputs the resulting time domain signal as a speech signal of the conversion target domain by the output unit 90.

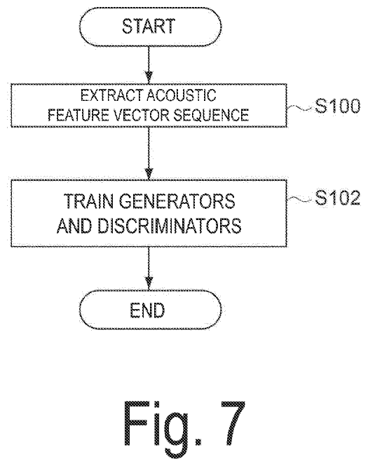

Each of the data conversion training apparatus 100 and the data conversion apparatus 150 is implemented by a computer 84 illustrated in FIG. 6, as an example. The computer 84 includes a CPU 86, a memory 88, a storage unit 92 storing a program 82, a display unit 94 including a monitor, and an input unit 96 including a keyboard and a mouse. The CPU 86, the memory 88, the storage unit 92, the display unit 94, and the input unit 96 are connected to each other via a bus 98.

The storage unit 92 is implemented by an HDD, an SSD, a flash memory, or the like. The storage unit 92 stores the program 82 for causing the computer 84 to function as the data conversion training apparatus 100 or the data conversion apparatus 150. The CPU 86 reads out the program 82 from the storage unit 92 and expands it into the memory 88 to execute the program 82. Note that the program 82 may be stored in a computer readable medium and provided.

Action of data conversion training apparatus according to embodiment of present invention Next, actions of the data conversion training apparatus 100 according to the embodiment of the present invention will be described. When the input unit 10 receives a set of speech signals of the conversion source domain and a set of speech signals of the conversion target domain, the data conversion training apparatus 100 executes a data conversion training processing routine illustrated in FIG. 7.

First, in step S100, the acoustic feature extraction unit 30 extracts an acoustic feature sequence from each of the input speech signals of the conversion source domain. An acoustic feature sequence is also extracted from each of the input speech signals of the conversion target domain.

Next, in step S102, based on the acoustic feature sequences of the speech signals of the conversion source domain and the acoustic feature sequences of the speech signals of the conversion target domain, the training unit 32 trains the forward generator G_{X→Y}, the inverse generator G_{Y→X}, the conversion target discriminators D_{Y} and D_{Y}′, and the conversion source discriminators D_{X} and D_{X}′, and outputs training results by the output unit 50 to terminate the data conversion training processing routine.

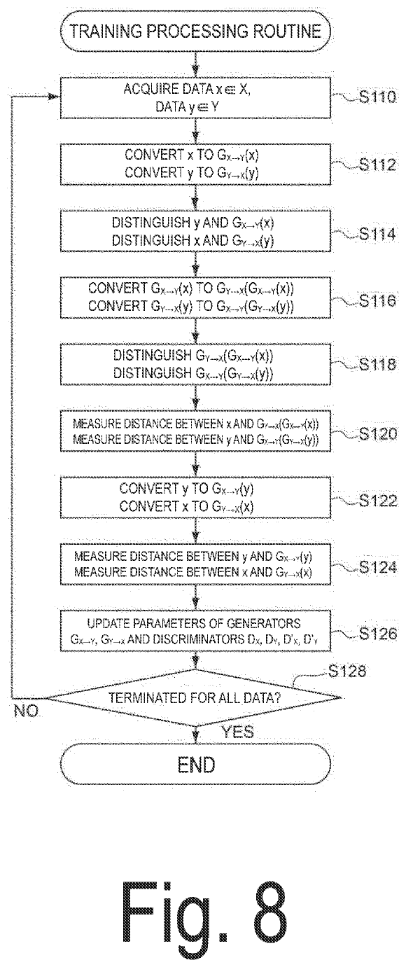

The processing of the training unit 32 in step S102 is realized by the processing routine illustrated in FIG. 8.

First, in step S110, only one acoustic feature sequence x in a speech signal of the conversion source domain is randomly acquired from the set X of acoustic feature sequences in speech signals of the conversion source domain. In addition, only one acoustic feature sequence y in a speech signal of the conversion target domain is randomly acquired from the set Y of acoustic feature sequences in speech signals of the conversion target domain.

In step S112, the forward generator G_{X→Y} is used to convert the acoustic feature sequence x in the speech signal of the conversion source domain to forward generation data G_{X→Y}(x). The inverse generator G_{Y→X} is used to convert the acoustic feature sequence y in the speech signal of the conversion target domain to inverse generation data G_{Y→X}(y).

In step S114, the conversion target discriminator D_{Y} is used to acquire a distinguishing result of the forward generation data G_{X→Y}(x) and a distinguishing result of the acoustic feature sequence y in the speech signal of the conversion target domain. The conversion source discriminator D_{X} is used to acquire a distinguishing result of the inverse generation data G_{Y→X}(y) and a distinguishing result of the acoustic feature sequence x in the speech signal of the conversion source domain.

In step S116, the inverse generator G_{Y→X} is used to convert the forward generation data G_{X→Y}(x) to inverse generation data G_{Y→X} (G_{X→Y}(x)). The forward generator G_{X→Y} is used to convert the inverse generation data G_{Y→X}(y) to forward generation data G_{X→Y} (G_{Y→X}(y)).

In step S118, the conversion target discriminator D_{Y}′ is used to acquire a distinguishing result of the forward generation data G_{X→Y} (G_{Y→X}(y)) and a distinguishing result of the acoustic feature sequence y in the speech signal of the conversion target domain. In addition, the conversion source discriminator D_{X}′ is used to acquire a distinguishing result of the inverse generation data G_{Y→X} (G_{X→Y}(x)) and a distinguishing result of the acoustic feature sequence x in the speech signal of the conversion source domain.

In step S120, a distance between the acoustic feature sequence x in the speech signal of the conversion source domain and the inverse generation data G_{Y→X} (G_{X→Y}(x)) is measured. In addition, a distance between the acoustic feature sequence y in the speech signal of the conversion target domain and the forward generation data G_{X→Y} (G_{Y→X}(y)) is measured.

In step S122, the forward generator G_{X→Y} is used to convert the acoustic feature sequence y in the speech signal of the conversion target domain to forward generation data G_{X→Y}(y). In addition, the inverse generator G_{Y→X} is used to convert the acoustic feature sequence x in the speech signal of the conversion source domain to inverse generation data G_{Y→X}(x).

In step S124, a distance between the acoustic feature sequence y in the speech signal of the conversion target domain and the forward generation data G_{X→Y}(y) is measured. In addition, a distance between the acoustic feature sequence x in the speech signal of the conversion source domain and the inverse generation data G_{Y→X}(x) is measured.

In step S126, parameters of the forward generator G_{X→Y} and the inverse generator G_{Y→X} are trained so as to minimize the value of the objective function expressed in Equation (5) above, based on the various data obtained in steps S114, S118, S120, and S124 above. In addition, the training unit 32 trains parameters of the conversion target discriminators D_{Y} and D_{Y}′, and the conversion source discriminators D_{X} and D_{X}′ so as to maximize the value of the objective function expressed in Equation (5) above, based on the various data output in steps S114, S118, S120, and S124 above.

At step S128, it is determined whether or not the processing routine has been terminated for all data. When the processing routine has not been terminated for all data, the processing returns to step S100 to perform processing of steps S110 to S126 again.

On the other hand, if the processing routine has been terminated for all the data, the processing is terminated.

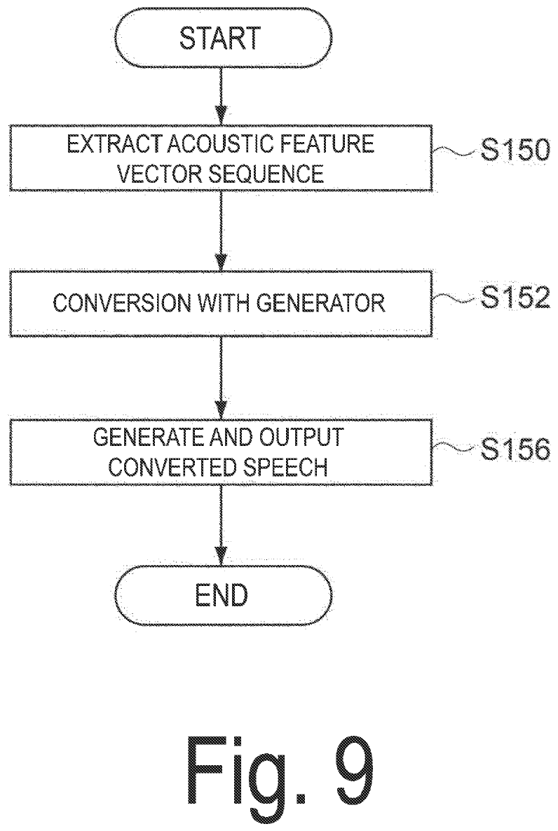

Action of data conversion apparatus according to embodiment of present invention Next, actions of the data conversion apparatus 150 according to the embodiment of the present invention will be described. The input unit 60 receives training results by the data conversion training apparatus 100. in addition, upon receiving a speech signal of the conversion source domain by the input unit 60, the data conversion apparatus 150 executes the data conversion processing routine illustrated in FIG. 9.

First, in step S150, an acoustic feature sequence is extracted from the input speech signal of the conversion source domain.

Next, in step S152, the forward generator G_{X→Y} trained by the data conversion training apparatus 100 is used to estimate an acoustic feature sequence of a speech signal of the conversion target domain from the acoustic feature sequence extracted by the acoustic feature extraction unit 72.

In step S156, a time domain signal is generated from the estimated acoustic feature sequence of the speech signal of the conversion target domain and output as a speech signal of the conversion target domain by the output unit 90, and the data conversion processing routine is terminated.

### Experimental Results

Speech conversion experiments were conducted using speech data of Voice Conversion Challenge (VCC) 2018 (female speaker VCC2SF3, male speaker VCC2SM3, female speaker VCC2TF1, male speaker VCC2TM1) to confirm the data conversion effect by the technique of the embodiment of the present invention.

For each speaker, 81 sentences were used as training data and 35 sentences were used as test data, and a sampling frequency for all speech signals was set to 22.05 kHz. For each utterance, a spectral envelope, a fundamental frequency (F₀), and a non-periodic indicator were extracted by WORLD analysis to perform a 35-order Mel-cepstrum analysis on the extracted spectral envelope sequence.

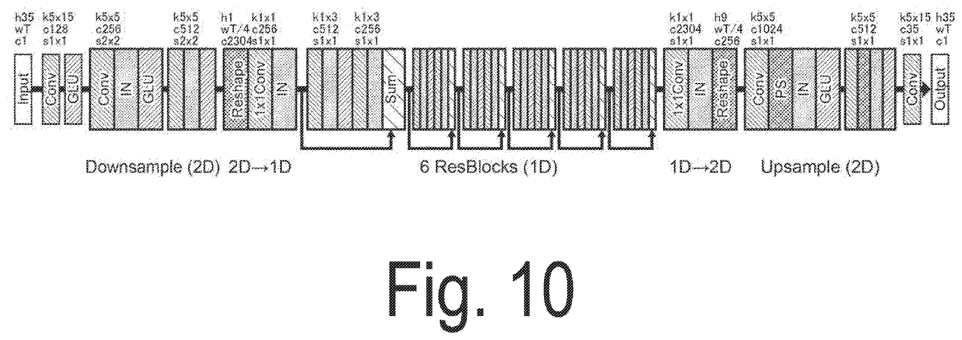

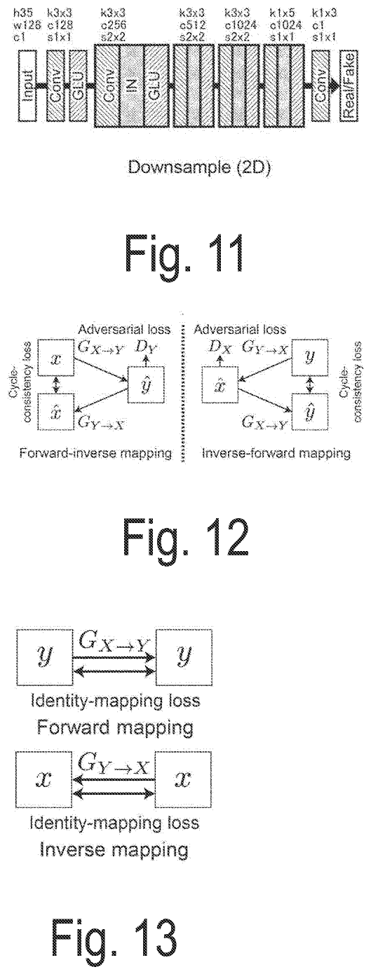

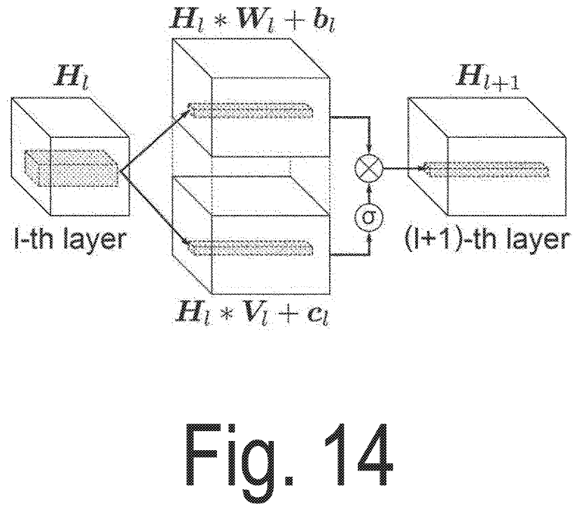

In the present experiment, a network configuration of each of the forward generator G_{X→Y} and the inverse generator G_{Y→X} was as illustrated in FIG. 10, and a network configuration of each of the conversion target discriminator D_{Y} and the conversion source discriminator D_{X} was as illustrated in FIG. 11.

Here, in FIGS. 10 and 11 above, “c”, “h”, and “w” represent a channel, a height, and a width, respectively, when input/output of the generators and input/output of the discriminators each are regarded as an image. “Conv”, “Batch norm”, “GLU”, “Deconv”, and “Softmax” represent a convolutional layer, a batch normalized layer, a gated linear unit, a transposed convolutional layer, and a softmax layer, respectively. In the convolutional layer or the transposed convolutional layer, “k”, “c”, and “s” represent a kernel size, the number of output channels, and a stride width, respectively.

As experimental results of the speech conversion, the results evaluated by Mel-cepstral distortion (MCD) are shown in Table 1. In this Mel-cepstral distortion, a difference of a global structure (overall variation in a sequence data) between data of the conversion source and data of the conversion target can be evaluated, indicating that a smaller value is better.

TABLE 1

| | Method | | | | | | |
|---|---|---|---|---|---|---|---|
| | CycleGAN-VC2 | | | Intra-gender | | Inter-gender | |
| No. | Adv. | G | D | SF-TF | SM-TM | SM-TF | SF-TM |
| 1 | 1Step | 2-1-2D | Patch | 6.86 ± .04 | 6.32 ± .06 | 7.36 ± .04 | 6.28 ± .04 |
| 2 | 2Step | 1D | Patch | 6.86 ± .04 | 6.73 ± .08 | 7.77 ± .07 | 6.41 ± .01 |
| 3 | 2Step | 2D | Patch | 7.01 ± .07 | 6.63 ± .03 | 7.63 ± .03 | 6.73 ± .04 |
| 4 | 2Step | 2-1-2D | Full | 7.01 ± .07 | 6.45 ± .05 | 7.41 ± .04 | 6.51 ± .02 |
| 5 | 2Step | 2-1-2D | Patch | 6.83 ± .01 | 6.31 ± .03 | 7.22 ± .05 | 6.26 ± .03 |

The first row indicates a case where the objective function of the related art is used, that is, the objective function obtained by removing the second adversarial loss from Equation (5) above. For the second to fifth rows, as the objective function, the function expressed by Equation (5) above is used. When the first row and the fifth row are compared to each other, it can be seen that the speech conversion accuracy is improved for the global structure by using the objective function according to the present embodiment.

As the experimental results of speech conversion, results evaluated by a modulation spectra distance (MSD) are shown in Table 2. In this modulation spectra distance, a difference of a detailed structure (fine fluctuation of sequence data) between data of the conversion source and data of the conversion target can be evaluated, indicating that a smaller value is better.

TABLE 2

| | Method | | | | | | |
|---|---|---|---|---|---|---|---|
| | CycleGAN-VC2 | | | Intra-gender | | Inter-gender | |
| No. | Adv. | G | D | SF-TF | SM-TM | SM-TF | SF-TM |
| 1 | 1Step | 2-1-2D | Patch | 1.60 ± .02 | 1.63 ± .05 | 1.54 ± .03 | 1.56 ± .04 |
| 2 | 2Step | 1D | Patch | 3.31 ± .36 | 4.26 ± .37 | 2.04 ± .21 | 5.03 ± .32 |
| 3 | 2Step | 2D | Patch | 1.57 ± .07 | 1.54 ± .01 | 1.46 ± .03 | 1.66 ± .07 |
| 4 | 2Step | 2-1-2D | Full | 1.52 ± .02 | 1.56 ± .04 | 1.47 ± .01 | 1.67 ± .06 |
| 5 | 2Step | 2-1-2D | Patch | 1.49 ± .01 | 1.53 ± .02 | 1.45 ± .00 | 1.52 ± .01 |

When the first row and the fifth row are compared to each other, it can be seen that the speech conversion accuracy is improved for the detailed structure by using the objective function according to the present embodiment. In Table 1 and Table 2, the second row indicates a case where the generator illustrated in FIG. 16 above is used. When the second row and the fifth row are compared to each other, it can be seen that the speech conversion accuracy is improved by using the generator according to the present embodiment. In Table 1 and Table 2, the third row indicates a case where the generator illustrated in FIG. 18 above is used. When the third row and the fifth row are compared to each other, it can be seen that the speech conversion accuracy is improved by using the generator according to the present embodiment.

In Table 1 and Table 2, the fourth row indicates a case where the discriminator illustrated in FIG. 19 above is used. When the fourth row and the fifth row are compared to each other, it can be seen that the speech conversion accuracy is improved for the global structure and the detailed structure by using the generator according to the present embodiment.

As described above, the data conversion training apparatus according to the embodiment of the present invention trains the forward generator, the inverse generator, the conversion target discriminators, and the conversion source discriminators so as to optimize the value of the objective function represented by six types of results described next. Here, the first one is a distinguishing result for forward generation data generated by the forward generator, which is obtained by the conversion target discriminator configured to distinguish whether or not data is the forward generation data generated by the forward generator. The second one is a distance between data of a conversion source domain and inverse generation data generated by the inverse generator from the forward generation data generated by the forward generator from the data of the conversion source domain. The third one is a distinguishing result for the inverse generation data generated by the inverse generator from the forward generation data, which is obtained by the conversion source discriminator configured to distinguish whether or not data is the inverse generation data generated by the inverse generator. The fourth one is a distinguishing result for inverse generation data generated by the inverse generator, which is obtained by the conversion source discriminator configured to distinguish whether or not data is the inverse generation data generated by the inverse generator. The fifth one is a distance between data of the conversion target domain and forward generation data generated by the forward generator from the inverse generation data generated by the inverse generator from the data of the conversion target domain. Then, the sixth one is a distinguishing result for the forward generation data generated by the forward generator from the inverse generation data, which is obtained by the conversion target discriminator configured to distinguish whether or not data is the forward generation data generated by the forward generator. Each of the forward and inverse generators includes a combination of the 2D CNN and the 1D CNN, and includes a down-sampling converter G1, a main converter G2, and an up-sampling converter G3. This can train the generator that is capable of accurate conversion to data of the conversion target domain.

Further, each of the forward generator and the inverse generator of the data conversion apparatus according to the embodiment of the present invention is a combination of the 2D CNN and the 1D CNN, and includes the down-sampling converter G1, the main converter G2, and the up-sampling converter G3. This allows accurate conversion to data of the conversion target domain.

Note that the present invention is not limited to the above-described embodiment, and various modifications and applications may be made without departing from the gist of the present invention.

For example, although in the embodiment described above, the data conversion training apparatus and the data conversion apparatus are configured as separate apparatuses, they may be configured as a single apparatus.

Furthermore, the data to be converted is an acoustic feature sequence of a speech signal, and a case where speaker conversion is performed from a female to a male has been described as an example, but the present invention is not limited thereto. For example, the present invention may be applied to a case where the data to be converted is an acoustic feature sequence of a sound signal and melody conversion is performed. For example, melody is converted from classical music to rock music.

Further, the present invention may be applied to a case where the data to be converted is an acoustic feature sequence of a sound signal and musical instrument conversion is performed. For example, the musical instrument is converted from a piano to a flute.

In addition, the present invention may be applied to a case where the data to be converted is an acoustic feature sequence of a speech signal and emotion conversion is performed. For example, conversion is performed from an angry voice to a pleasing voice.

Furthermore, although the case where the data to be converted is an acoustic feature sequence of a speech signal has been described as an example, the present invention is not limited thereto, and the data to be converted may be a feature or a feature sequence of images, sensor data, video, text, or the like. For example, when the conversion source domain is abnormal data of a type A machine, abnormal data in which naturalness of abnormal data of a type B machine and plausibility of abnormal data of the type A machine or type B machine are improved, which is abnormal data of the type B machine and other abnormal data of the type A machine obtained by applying the present invention, can be obtained.

Although the case where the data to be converted is time series data has been described as an example, the present invention is not limited thereto and the data to be converted may be data other than time series data. For example, the data to be converted may be an image.

Furthermore, the parameters of the conversion target discriminators D_{Y} and D_{Y}′ may be common. Furthermore, the parameters of the conversion source discriminators D_{X} and D_{X}′ may be common.

In addition, in the generator, a 2D CNN may be interposed between central 1D CNNs, and a 1D CNN and a 2D CNN may alternately be disposed in the part of the central 1D CNN. For example, two or more 1D CNNs and 2D CNNs can be combined by adding processing of deforming an output result of a previous CNN so as to be suitable for a next CNN and processing of inversely deforming an output result of the next CNN. Further, although in the embodiments described above, the case where the 1D CNN and the 2D CNN are combined has been described as an example, any CNNs may be combined like an ND CNN and an MD CNN. In addition, for the adversarial loss, the case where binary cross entropy is used, but any objective function of GAN such as least square loss or Wasserstein loss may be used.

While the data conversion training apparatus and the data conversion apparatus described above each include a computer system, this “computer system” is to include a web page providing environment (or displaying environment) when the WWW system is used.

In addition, although an embodiment in which the programs are installed in advance has been described in the present specification of the present application, such programs can be provided by being stored in a computer-readable recording medium.

### REFERENCE SIGNS LIST

10, 60 Input unit

20, 70 Operation Unit

30 Acoustic feature extraction unit

32 Training unit

50, 90 Output unit

72 Acoustic feature extraction unit

74 Data conversion unit

78 Converted speech generation unit

82 Program

84 Computer

100 Data conversion training apparatus

150 Data conversion apparatus

1. A data conversion training apparatus comprising:
a receiver configured to receive a set of data of a conversion source domain and a set of data of a conversion target domain; and
a trainer configured to train a forward generator and an inverse generator, the forward generator being configured to generate data of the conversion target domain from data of the conversion source domain based on the set of data of the conversion source domain and the set of data of the conversion target domain, the inverse generator being configured to generate data of the conversion source domain from data of the conversion target domain, wherein
the trainer trains the forward generator, the inverse generator, a first conversion target discriminator, a second conversion target discriminator, a first conversion source discriminator, and a second conversion source discriminator so as to optimize a value of an objective function expressed by using:
a distinguishing result, by the first conversion target discriminator, for forward generation data generated by the forward generator, the first conversion target discriminator being configured to distinguish whether data is the forward generation data generated by the forward generator;
a distinguishing result, by the first conversion target discriminator, for the data of the conversion target domain;
a distance between the data of the conversion source domain and inverse generation data generated by the inverse generator from the forward generation data generated by the forward generator from the data of the conversion source domain;
a distinguishing result, by the second conversion source discriminator, for the inverse generation data generated by the inverse generator from the forward generation data, the second conversion source discriminator being configured to distinguish whether data is the inverse generation data generated by the inverse generator;
a distinguishing result, by the first conversion source discriminator, for inverse generation data generated by the inverse generator, the first conversion source discriminator being configured to distinguish whether data is the inverse generation data generated by the inverse generator;
a distinguishing result, by the first conversion source discriminator, for the data of the conversion source domain;
a distance between the data of the conversion target domain and forward generation data generated by the forward generator from the inverse generation data generated by the inverse generator from the data of the conversion target domain; and
a distinguishing result, by the second conversion target discriminator, for the forward generation data generated by the forward generator from the inverse generation data, the second conversion target discriminator being configured to distinguish whether data is the forward generation data generated by the forward generator.

2. The data conversion training apparatus according to claim 1, wherein
the trainer separately trains a parameter of the first conversion target discriminator configured to distinguish the forward generation data generated by the forward generator and a parameter of the second conversion target discriminator configured to distinguish the forward generation data generated by the forward generator from the inverse generation data, and separately trains a parameter of the first conversion source discriminator configured to distinguish the inverse generation data generated by the inverse generator and a parameter of the second conversion source discriminator configured to distinguish the inverse generation data generated by the inverse generator from the forward generation data.

3. The data conversion training apparatus according to claim 1,
wherein the objective function is expressed by further using:
a distance between the data of the conversion target domain and the forward generation data generated by the forward generator from the data of the conversion target domain; and
a distance between the data of the conversion source domain and the inverse generation data generated by the inverse generator from the data of the conversion source domain

4. A data conversion training apparatus comprising:
a receiver configured to receive a set of data of a conversion source domain and a set of data of a conversion target domain; and
a trainer configured to train, based on the set of data of the conversion source domain and the set of data of the conversion target domain, a forward generator, an inverse generator, a conversion target discriminator, and a conversion source discriminator, the forward generator being configured to generate data of the conversion target domain from data of the conversion source domain, the inverse generator being configured to generate data of the conversion source domain from data of the conversion target domain, the conversion target discriminator being configured to distinguish whether data is forward generation data generated by the forward generator, the conversion source discriminator being configured to distinguish whether data is inverse generation data generated by the inverse generator, wherein
the forward generator includes:
a down-sampling converter configured to perform down-sampling in which a local structure of the data of the conversion source domain is retained;
a dynamic converter configured to dynamically convert output data of the down-sampling converter; and
an up-sampling converter configured to generate the forward generation data by up-sampling of output data of the dynamic converter, and
the inverse generator includes:
a down-sampling converter configured to perform down-sampling in which a local structure of the data of the conversion target domain is retained;
a dynamic converter configured to dynamically convert output data of the down-sampling converter; and
an up-sampling converter configured to generate the inverse generation data by up-sampling of output data of the dynamic converter.

5. The data conversion training apparatus according to claim 4, wherein
the data is a feature sequence,
the down-sampling converter performs down-sampling by convolution of the data in a local domain in each of a sequence direction and a feature dimension direction, and
the dynamic converter dynamically converts the output data of the down-sampling converter by using convolution of the output data of the down-sampling converter in an entire domain in the feature dimension direction and in the local domain in a sequence direction.

6. A data conversion apparatus comprising:
a receiver configured to receive data of a conversion source domain; and
a data converter configured to generate data of a conversion target domain from the data of the conversion source domain received by the receiver, by using a forward generator configured to generate the data of the conversion target domain from the data of the conversion source domain, wherein
the forward generator includes:
a down-sampling converter configured to perform down-sampling in which a local structure of the data of the conversion source domain is retained;
a dynamic converter configured to dynamically convert output data of the down-sampling converter; and
an up-sampling converter configured to generate forward generation data by up-sampling of output data of the dynamic converter.

7-12. (canceled)

13. The data conversion training apparatus according to claim 2, wherein the objective function is expressed by further using:
a distance between the data of the conversion target domain and the forward generation data generated by the forward generator from the data of the conversion target domain; and
a distance between the data of the conversion source domain and the inverse generation data generated by the inverse generator from the data of the conversion source domain.
